(19) United States
(12) Patent Application Publication
(10) Pub. No.: US 2016/0340524 A1
(43) Pub. Date: Nov. 24, 2016

(54) CALCINED DIATOMITE PRODUCTS WITH LOW CRISTOBALITE CONTENT

(71) Applicant: Imerys Filtration Minerals, Inc., San Jose, CA (US)

(72) Inventor: Bo Wang, Lompoc, CA (US)

(21) Appl. No.: 15/225,204

(22) Filed: Aug. 1, 2016

Related U.S. Application Data
(63) Continuation of application No. 14/018,617, filed on Sep. 5, 2013.
Application No. 14/018,617 is a continuation of application No. 14/018,617, filed on Sep. 5, 2013.
Application No. 14/018,617 is a continuation of application No. 12/595,864, filed on Nov. 10, 2009, now abandoned.
(60) Provisional application No. 60/912,462, filed on Apr. 18, 2007.

(51) Int. Cl. C09D 7/12; C09D 123/06

(52) U.S. Cl. CPC C09D 7/1216; C09D 123/06; C08K 3/34

(57) ABSTRACT

Described herein is a flux-calcined diatomite composition having a cristobalite content of less than about 5% by weight relative to the total weight of the flux-calcined composition and a whiteness of greater than about 90. Also described herein is a process for producing flux-calcined diatomite compositions including calcining a feed composition including diatomite having an iron content of at least about 0.5% by weight relative to the total weight of the feed composition in the presence of at least one flux including at least one alkali metal.

### CLAIM OF PRIORITY

This application claims the benefit of priority to U.S. Provisional Patent Application No. 60/912,462 filed Apr. 18, 2007, which is incorporated by reference herein in its entirety.

### FIELD OF THE INVENTION

Disclosed herein is a calcined diatomite composition having a reduced cristobalite content and improved whiteness, as well as processes for making such a composition, including processes comprising at least one flux.

### BACKGROUND OF THE INVENTION

Diatomite is a sedimentary rock that comprises fossilized skeletons of diatoms, which are unicellular aquatic plants related to algae. The skeletons comprise opal-like, amorphous silica (SiO₂.H₂O) comprising small amounts of microcrystalline materials. Diatomite may also contain small amounts of other substances, including but not limited to Na₂O, MgO, Al₂O₃, SO₃, Cl, MnO, Fe₂O₃, TiO₂, P₂O₅, CaO, and K₂O.

The term diatomite, or diatomaceous earth, is inclusive of various diatom species that may occur in a wide variety of shapes, such as cylindrical, rod-like, and star-shaped. Diatoms are generally characterized by a hollow interior and a perforated surface. The unique porous silica structure of diatomite may allow for certain properties, such as high absorptive capacity, high surface area, chemical stability, and low bulk density. Those properties, among others, may make diatomite particularly useful for filtration processes, for example, in the food and beverage, biotechnology, pharmaceutical, and chemical industries. For instance, diatomite is often used as a filter component for antibiotics, pharmaceuticals, chemicals, solvents, vitamins, edible oils and fats, fruit juices, glucose, sugar, water, beer, and wine. Diatomite may also be used as a filler in paint, paper, asphalt, and plastic.

Diatomite may also comprise moisture and various organic substances. Thus, before using diatomite in filtration processes, the raw material typically undergoes at least one conditioning process, such as drying, calcining, milling, classification, crushing, and grinding. For instance, diatomite is generally dried and calcined for reasons such as to remove moisture; to convert organic substances into oxides, silicate, or aluminosilicates; and, to sinter various undesirable inorganic compounds such as calcium carbonate, calcium sulfate, iron derivatives, and sulfides. Calcination may also serve to agglomerate the diatoms and their fragments into aggregates, so as to reduce the content of fine particles and increase permeability. Calcination is typically carried out at temperatures ranging from 600° C. to 1300° C., such as from 600° C. to 1200° C., from 700 to 900° C., 800° C. to 1000° C., or from 900° C. to 1100° C.

Diatomite may also be flux calcined by introducing an alkaline flux, for example, a sodium compound such as sodium carbonate, during calcination. Flux calcination may be performed for various reasons, such as to decrease the energy input required to calcine diatomite, and/or to reduce the temperature at which sintering and agglomeration of diatomite particles occur (thus permitting larger agglomerates). Flux calcination may be carried out at temperatures ranging from 300° C. to 1300° C., such as from 700 to 900° C., 800° C. to 1200° C., or from 900° C. to 1100° C., or 900° C. to 1000° C. During flux calcination, the porosity and specific surface area of the diatomite may decrease and, in many cases, a substantial amount of the amorphous SiO₂ may be transformed into a crystalline phase called cristobalite. In the case of an alkaline flux with a sodium compound, a large concentration of cristobalite may form due to the incorporation of sodium ions into the silica framework.

Cristobalite is the second most common crystalline form of SiO₂, existing in the β-phase at higher temperatures, such as temperatures greater than 1470° C., and in the α-form at lower temperatures, such as temperatures around 270° C. The crystalline forms of SiO₂, such as quartz, cristobalite, and tridymite, may cause silicosis and are suspected to cause cancer. The International Agency for Research on Cancer (IARC) classifies all crystalline phases of SiO₂ as carcinogenic. Thus, cristobalite may pose a potential health risk during processing and/or disposal of the filtration media in which it is included, during filtration of commercial products, and during consumption and/or use of the filtered product itself.

Color is important for a filler in any application, particularly where color of the end product is important. Whiter filler products generally have greater utility, as they can be used in all colored and white products and, relative to non-white fillers, may reduce the demand for expensive white pigments, such as titanium dioxide. For those reasons, a calcined diatomite composition having a reduced cristobalite content and improved whiteness is desirable. Calcination may be performed with or without flux; however, calcination of diatomite without flux may produce a pink color due to a higher concentration of irons, particularly ferric irons, in the diatomite. Although conventional flux calcined diatomite products are generally white in color, they may contain high concentration of cristobalite when soda ash is used as the flux.

Attempts have been made in the prior art to reduce the amount of cristobalite in treated diatomite products. For instance, German Patent Application No. 102 35 866, and Antoni et al., “Effects of the fluxing agents on the formation of crystalline silica phases during calcination of kieselguhr,” MBAA TQ, 42(4): 290-296 (2005), suggest that potassium may inhibit of cristobalite formation during calcination of diatomaceous earth.

U.S. Pat. No. 5,179,062 appears to describe a process for the production of calcined diatomaceous filtration agents having a cristobalite content of less than 1% and a permeability ranging from 0.06 to 0.4 Darcys (Da). Similarly, U.S. Pat. No. 5,710,090 appears to describe pink (i.e., calcined) diatomite agglomerates having a cristobalite content of less than 1.5% and a permeability ranging from 20 to 500 milliDarcys (mDa). However, those references do not disclose a high whiteness, do not disclose straight calcination (i.e., without introduction of a flux), and do not disclose processes for flux calcining diatomite.

In addition, other references, such as Japanese Patent No. 11-15814, appear to disclose the heat treatment of diatomaceous earth in the presence of an alkali such as NaOH to destroy the crystal structure of α-cristobalite. However, flux calcining diatomite in the presence of sodium atoms may not always yield products having satisfactory properties, such as desired permeability and/or low cristobalite content.

Thus, it would be useful to provide calcined diatomite compositions having at least one of reduced cristobalite content and improved whiteness, and processes to produce such diatomite compositions, including processes comprising at least one flux.

### SUMMARY OF THE INVENTION

Disclosed herein is a calcined diatomite composition having a cristobalite content of less than about 5% by weight relative to the total weight of the calcined composition and a whiteness (L value) of at least about 80. In one embodiment, the composition is a flux calcined diatomite composition. In another embodiment, the composition has a whiteness of at least about 90.

Also disclosed herein is a process for producing flux calcined diatomite compositions comprising calcining at least one feed composition comprising diatomite comprising an iron content of less than about 0.5% by weight relative to the total weight of the feed composition in the presence of at least one flux comprising at least one alkali metal. In one embodiment, the at least one alkali metal is chosen from potassium, rubidium, and cesium.

Further disclosed herein is a flux calcined diatomite composition having a cristobalite content of less than about 5% by weight relative to the total weight of the composition and an iron content of less than about 1% by weight relative to the total weight of the composition.

### DETAILED DESCRIPTION OF THE INVENTION

### Compositions

Among other applications, diatomites are suitable for use as filler products, for instance, in paints, coatings, and polymers. However, filler applications often require a high level of filler brightness or whiteness so as not to interfere with the color of the final product. Often, whiteness also has an effect on the brightness of a composition or filler application. The calcined diatomite products disclosed herein may exhibit a whiteness (L value) of about 80 or more. In one embodiment, the whiteness is greater than about 85. In another embodiment, the whiteness is greater than about 90. In a further embodiment, the whiteness is greater than about 91. In yet another embodiment, the whiteness may be greater than about 92. In yet a further embodiment, the whiteness may be greater than about 93. In still another embodiment, the whiteness may be greater than about 94. In still a further embodiment, the whiteness is from about 80 to about 95. In another embodiment, the whiteness is from about 90 to about 95.

Whiteness may be determined using the Hunter (L, a, b) scale, as discussed in detail herein. The whiteness of the diatomite product corresponds to the Hunter L value. The diatomite products of the present disclosure may exhibit Hunter a value of less than about 1. In one embodiment, the Hunter a value is less than about 0.5. In another embodiment, the Hunter a value is from about 0.25 to about 1. In a further embodiment, the Hunter a value is from about 0.25 to about 0.5. The Hunter b value of the diatomite products disclosed herein may be less than about 8. In one embodiment, the Hunter b value is less than about 6. In another embodiment, the Hunter b value is less than about 4. In a further embodiment, the Hunter b value is from about 3 to about 8. In yet another embodiment, the Hunter b value is from about 3 to about 6.

The cristobalite content of the calcined diatomite described herein is less than about 5% by weight relative to the total weight of the calcined diatomite. In one embodiment, the cristobalite content is less than about 3% by weight. In another embodiment, the cristobalite content is less than about 2% by weight. In a further embodiment, the cristobalite content is less than about 1% by weight. In yet another embodiment, the cristobalite content is less than about 0.5% by weight. In yet a further embodiment, the cristobalite content is less than about 0.2% by weight. In still another embodiment, the cristobalite content is less than about 0.1% by weight. In still a further embodiment, the cristobalite content is from about 0.1% to about 5% by weight. In another embodiment, the cristobalite content is from about 0.5% to about 2% by weight.

The calcined diatomite composition may further be characterized by the particle sizes of the diatomite comprised therein. For instance, the composition may be characterized by the mean diameter of the diatomite comprised therein, or d₅₀, defined herein as the size at which 50 percent of the particle volume is accounted for by particles having a diameter less than or equal to this value. In one embodiment, the calcined diatomite composition has a d₅₀ of less than about 50 μm. In another embodiment, the mean diameter is less than about 30 μm. In a further embodiment, the mean diameter is less than about 20 μm. In still a further embodiment, the mean diameter is less than about 15 μm. In another embodiment, the mean diameter is less than about 10 μm. In yet another embodiment, the mean diameter is less than about 5 μm. In yet a further embodiment, the mean diameter is from about 5 μm to about 50 μm. In still another embodiment, the mean diameter is from about 10 μm to about 30 μm.

In addition, the diatomite composition may be characterized by a d₉₀ value, defined as the size at which 90 percent of the diatomite particle volume is accounted for by particles having a diameter less than or equal to this value. In one embodiment, the d₉₀ value is less than about 150 μm. In another embodiment, the d₉₀ value is less than about 100 μm. In a further embodiment, the d₉₀ value is less than about 80 μm. In yet another embodiment, the d₉₀ value is less than about 75 μm. In yet a further embodiment, the d₉₀ value is less than about 60 μm. In still another embodiment, the d₉₀ value is less than about 50 μm. In still a further embodiment, the d₉₀ value is less than about 40 μm. In another embodiment, the d₉₀ value is less than about 30 μm. In a further embodiment, the d₉₀ value is less than about 20 μm. In yet another embodiment, the d₉₀ value is less than about 10 μm. In yet a further embodiment, the d₉₀ value is from about 10 μm to about 150 μm. In still another embodiment, the d₉₀ value is from about 70 μm to about 130 μm. In still a further embodiment, the d₉₀ value is from about 30 μm to about 100 μm.

Diatomite typically contains various inorganic compounds, such as for instance iron compounds. The most common type of iron compound found in diatomite is Fe₂O₃. In one embodiment, the diatomite product of the present disclosure has an iron content of less than about 1.0% by weight, typically in the form of iron oxide, relative to the total weight of the diatomite product. In another embodiment, the diatomite product has an iron content of less than about 0.5%. In a further embodiment, the diatomite product has an iron content of less than about 0.4%. In yet another embodiment, the diatomite product has an iron content of less than about 0.3%. In yet a further embodiment, the diatomite product has an iron content from about 0.1% to about 1.0%. In still another embodiment, the diatomite product has an iron content from about 0.1% to about 0.5%.

### Processes

Also disclosed herein is a process for producing calcined diatomite compositions comprising a cristobalite content of less than about 5% by weight and a whiteness of greater than about 90, comprising calcining at least one feed composition comprising diatomite having an iron content of less than about 0.5% by weight relative to the total weight of the feed composition. One example of such a process may comprise calcining an at least one feed composition in the presence of at least one flux comprising at least one alkali metal. In one embodiment, the at least one alkali metal is sodium. In another embodiment, the at least one alkali metal is chosen from alkali metals having a larger atomic radius than that of sodium. In a further embodiment, the at least one alkali metal is potassium. In yet another embodiment, the at least one alkali metal is rubidium. In yet a further embodiment, the at least one alkali metal is cesium. While not wishing to be bound by theory, it is hypothesized that, unlike sodium ions that generally fit into the cristobalite crystal structure and facilitate cristobalite formation in diatomite during calcination, the ionic radius of the at least one alkali metal disclosed herein and comprised in at least one flux during calcination is such that the at least one alkali metal is too large to generally fit within the cristobalite crystal unit cells, so the crystal structure may become highly disordered as a result.

The at least one alkali metal of the at least one flux may be present in an amount greater than about 1% by weight relative to the total weight of the flux calcined diatomite composition. In one embodiment, the flux calcined diatomite comprises from about 1 to about 10% by weight of the at least one alkali metal. In another embodiment, the flux calcined diatomite comprises from about 3 to about 8% by weight of the at least one alkali metal. In a further embodiment, the flux calcined diatomite comprises from about 5 to about 8% by weight of the at least one alkali metal.

The at least one flux may be introduced in various forms, for example, salts of the at least one alkali metal. In one embodiment, the at least one flux is in the form of a carbonate salt. In another embodiment, the at least one flux is in the form of a chloride salt. In a further embodiment, the at least one flux is in the form of a nitrate salt. In yet another embodiment, the at least one flux is potassium carbonate. In yet a further embodiment, the at least one flux is rubidium carbonate. In still another embodiment, the at least one flux is cesium carbonate. In still a further embodiment, the at least one flux is sodium carbonate.

The at least one flux may be present in the initial feed composition in an amount ranging from about 2 to about 20% by weight relative to the total weight of the feed composition. In one embodiment, the at least one flux is present in an amount ranging from about 5 to about 20% by weight. In another embodiment, the at least one flux is present in an amount ranging from about 5 to about 11% by weight.

The calcination temperature and retention time may vary, in part depending on the equipment used for calcination and whether or not flux calcination is used. For example, calcination may be carried out at a temperature ranging from about 300 to about 1300° C. In one embodiment, calcination is carried out at a temperature ranging from about 600 to about 900° C. In another embodiment, calcination is carried out at a temperature ranging from about 800 to about 1200° C. In a further embodiment, calcination is carried out at a temperature ranging from about 900 to about 1100° C. Retention times may range from about a few seconds to about several minutes. In one embodiment, the retention time ranges from about 2 minutes to about 120 minutes. In another embodiment, the retention time ranges from about 10 to about 60 minutes. In a further embodiment, the retention time ranges from about 30 to about 60 minutes. In yet another embodiment, the retention time is about 30 minutes. In yet a further embodiment, the retention time is about 120 minutes. Flux calcination of diatomite may be performed in air, although other flux calcination environments are also suitable, for example, a reducing atmosphere.

Following completion of a flux calcination, the at least one alkali metal may be present in the flux calcined composition in the form of at least one alkali metal oxide. In one embodiment, the at least one alkali metal oxide is K₂O. In another embodiment, the at least one metal oxide is Rb₂O. In a further embodiment, the at least one metal oxide is Cs₂O. The at least one alkali metal oxide may be present in the final flux calcined composition in an amount of at least about 1% by weight relative to the total weight of the flux calcined composition. In one embodiment, the at least one alkali metal oxide is present in an amount ranging from about 1% to about 15% by weight. In another embodiment, the at least one alkali metal oxide is present in an amount ranging from about 3% to about 15% by weight. In a further embodiment, the at least one alkali metal oxide is present in an amount ranging from about 5% to about 11% by weight.

The feed diatomite composition before flux calcination, as well as the diatomite composite after flux calcination, may be optionally subjected to further treatment, including but not limited to drying, crushing, milling, classification, water treatment, and/or grinding. In one embodiment, the flux calcined diatomite composition is dried to remove or reduce moisture. The compositions may be dried in at least one dryer, such as a flash dryer and a rotary dryer, operating at temperatures ranging, for example, from about 70° C. to about 430° C. In another embodiment, the feed diatomite composition, the flux calcined diatomite composition, or both are lightly grinded to reduce the coarseness of the particles. In a further embodiment, the feed diatomite composition, the flux calcined diatomite composition, or both are grinded so as to minimally increase the ultra fine particle content of the diatomite composition. Excessive ultra fine particles may reduce filler performance, for example, anti-blocking in polymer films and flatting in paints and coatings.

### Measurement Protocols

Cristobalite Content

Cristobalite content may be measured, for example, by the quantitative X-ray diffraction method outlined in H. P. Klug and L. E. Alexander, X-Ray Diffraction Procedures for Polycrystalline and Amorphous Materials 531-563 (2nd ed. 1972). According to that method, a sample is milled in a mortar and pestle to a fine powder, then back-loaded into a sample holder. The sample and its holder are placed into the beam path of an X-ray diffraction system and exposed to collimated X-rays using an accelerating voltage of 40 kV and a current of 20 mA focused on a copper target. Diffraction data are acquired by step-scanning over the angular region representing the interplanar spacing within the crystalline lattice structure of cristobalite, yielding the greatest diffracted intensity. That region ranges from about 21 to about 23 2θ (2-theta), with data collected in 0.05 2θ steps, counted for 20 seconds per step. The net integrated peak intensity is compared with those of standards of cristobalite prepared by the standard additions method in amorphous silica to determine the weight percent of the cristobalite phase in a sample.

Color

The color of the diatomite product may be determined using the Hunter scale L, a, b color data collected on a Spectroplus Spectrophotometer (Color and Appearance Technology, Inc., Princeton, N.J.). The L value indicates the level of light or dark, the a value indicates the level of redness or greenness, and the b value indicates the level of yellowness or blueness. A krypton-filled incandescent lamp may be used as the light source. The instrument is calibrated according to the manufacturer's instructions using a highly polished black glass standard and a factory calibrated white opal glass standard. A plastic plate having a depression machined into it is filled with a sample, which is then compressed with a smooth-faced plate using a circular pressing motion. The smooth-faced plate is carefully removed to ensure an even, unmarred surface. The sample is then placed under the instrument's aperture for the measurements.

Anti-Block Performance

Anti-block performance refers to the ability to reduce adhesion or blocking of the plastic film surface. Anti-block performance may be measured by manufacturing a polyethylene film containing 2000 ppm of a diatomite product and measuring the anti-block performance of the film. The films are extruded into nominal 1.25 mm films, based on Equistar low density polyethylene (LDPE) 345-013 resin. 750 ppm of Chemtura Keramide E Ultra Power erucamide slip agent is added to each sample. Extrusion of the films is performed with a ¾ inch single screw extruder, equipped with a 2.5 inch blown film die. After conditioning the films for 24 hours at 30° C. and 50% relative humidity, the film samples are cut, destaticized, and prepared for optical and induced blocking tests based on ASTM D 3354 and ASTM D 1003, respectively. Anti-block performance may be evaluated by measuring the induced blocking properties, such as the force needed to separate two films stuck together. Anti-block performance may also be evaluated by measuring the haze of the film.

Particle Size Distribution

Particle size distribution may be quantified by determining the difference in particle size distribution between the components. One method employs a laser diffraction instrument, for example, a Leeds & Northrup Microtrac Model X-100. That instrument is fully automated, and the results are obtained using a volume distribution formatted in geometric progression of 100 channels, running for 30 seconds with the filter on. The distribution is characterized using an algorithm to interpret data characterized by a diameter, d. The d₅₀ and d₉₀ values of the sample may be identified by the instrument.

Alkali Metal Concentration

Alkali metal concentration in diatomite may be determined by “pressed binder matrix” X-ray fluorescence methods. A 3 g diatomite sample is added to 0.75 g of Spectroblend® binder (sold by Chemplex). The mixture is milled by shaking for 5 minutes in a tungsten carbide mixing vial with an impact ball. The resulting mixture is then pressed in a 31 mm die to 24,000 pounds per square inch (165 MPa) to form a pellet. Chemical composition is then determined using a Thermo ARL ADVANT'XP S-ray fluorescence (XRF) spectrometer equipped with a 60 KV rhodium target X-ray source. Peak intensities from spectra are analyzed by lineshape analysis comparison with single element reference spectra. The peak intensities for the diatomite standards are then converted into pure element count rates which are used for determining element contents in samples, by peak intensity and data fitting.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, unless otherwise indicated the numerical values set forth in the specific examples are reported as precisely as possible. Any numerical value, however, inherently contain certain errors necessarily resulting from the standard deviation found in their respective testing measurements.

The headers used in this specification are presented for the convenience of the reader and not intended to be limiting of the inventions described herein. By way of non-limiting illustration, concrete examples of certain embodiments of the present disclosure are given below.

### EXAMPLES

### Example 1

A diatomite ore from Alicante, Spain, was used as the feed material. The feed material had a median particle size (d₅₀) of 12.5 microns. The cristobalite in the feed material was less than 0.052% by weight, as measured by X-ray diffraction. 49 g of the feed material was mixed with 1 g of sodium carbonate and the mixture was calcined at 800° C. for 30 minutes in an electrical muffle furnace. The calcined product was then removed from the furnace and allowed to cool to room temperature. The flux calcined product was dispersed by brushing through an ASTM Number 30 screen with 600 micron openings before particle size and cristobalite measurement. The flux calcined product had a median particle size of 21 microns, a cristobalite content of 1.7% by weight, and Hunter L, a, and b values of 92.39, 0.43, and 4.99, respectively.

### Example 2

Example 1 was repeated using 48 g of diatomite ore and 2 g of sodium carbonate. The flux calcined product had a median particle size of 27.7 microns, a cristobalite content of 4.9% by weight, and Hunter L, a, and b values of 91.89, 0.29, and 4.31, respectively.

### Example 3

Example 1 was repeated using 47 g of diatomite ore and 3 g of sodium carbonate. The flux calcined product had a median particle size of 33.5 microns, a cristobalite content of 7.4% by weight, and Hunter L, a, and b values of 90.54, 0.26, and 3.59, respectively.

### Example 4

Example 1 was repeated using 46 g of diatomite ore and 4 g of sodium carbonate. The flux calcined product had a median particle size of 39.4 microns, a cristobalite content of 11.9% by weight, and Hunter L, a, and b values of 91.06, 0.26, and 3.70, respectively.

### Example 5

Example 1 was repeated using 49 g of diatomite ore and 1 g of potassium carbonate instead of sodium carbonate. The flux calcined product had a median particle size of 16.8 microns, a cristobalite content of 0.1% by weight, and Hunter L, a, and b values of 91.49, 0.64, and 5.44, respectively.

### Example 6

Example 5 was repeated using 48 g of diatomite ore and 2 g of potassium carbonate. The flux calcined product had a median particle size of 18 microns, a cristobalite content of 0.3% by weight, and Hunter L, a, and b values of 91.29, 0.41, and 4.83, respectively.

### Example 7

Example 5 was repeated using 47 g of diatomite ore and 3 g of potassium carbonate. The flux calcined product had a median particle size of 19.3 microns, a cristobalite content of 0.5% by weight, and Hunter L, a, and b values of 92.32, 0.48, and 5.04, respectively.

### Example 8

Example 5 was repeated using 46 g of diatomite ore and 4 g of potassium carbonate. The flux calcined product had a median particle size of 20 microns, a cristobalite content of 0.3% by weight, and Hunter L, a, and b values of 91.57, 0.35, and 4.70, respectively.

### Example 9

Example 1 was repeated using 48 g of diatomite ore and 2 g of sodium carbonate at a calcination temperature of 900° C. The flux calcined product had a median particle size of 45.4 microns, a cristobalite content of 23.3% by weight, and Hunter L, a, and b values of 94.18, 0.29, and 4.21, respectively.

### Example 10

Example 9 was repeated using 48 g of diatomite ore and 2 g of potassium carbonate instead of sodium carbonate. The flux calcined product had a median particle size of 28 microns, a cristobalite content of 1.6% by weight, and Hunter L, a, and b values of 92.98, 0.72, and 5.52, respectively.

### Example 11

Example 9 was repeated using 48 g of diatomite ore and 2 g of rubidium carbonate instead of sodium carbonate. The flux calcined product had a median particle size of 28.6 microns, a cristobalite content of 0.6% by weight, and Hunter L, a, and b values of 92.75, 0.84, and 5.69, respectively.

### Example 12

Example 9 was repeated using 48 g of diatomite ore and 2 g of cesium carbonate instead of sodium carbonate. The flux calcined product had a median particle size of 19.4 microns, a cristobalite content of less than 0.1% by weight, and Hunter L, a, and b values of 94.12, 0.41, and 4.85, respectively.

### Example 13

Example 2 was repeated with a calcination time of 60 minutes. The flux calcined product had a median particle size of 26.0 microns, a cristobalite content of 9.1% by weight, and Hunter L, a, and b values of 94.12, 0.41, and 4.85, respectively.

### Example 14

Example 2 was repeated with a calcination time of 120 minutes. The flux calcined product had a median particle size of 21.8 microns, a cristobalite content of 15.5% by weight, and Hunter L, a, and b values of 94.50, 0.39, and 4.49, respectively.

### Example 15

Example 6 was repeated with a calcination time of 60 minutes. The flux calcined product had a median particle size of 20 microns, a cristobalite content of 0.5% by weight, and Hunter L, a, and b values of 93.36, 0.70, and 5.40.

### Example 16

Example 6 was repeated with a calcination time of 120 minutes. The flux calcined product had a median particle size of 27.9 microns, a cristobalite content of 0.7% by weight, and Hunter L, a, and b values of 93.29, 0.81, and 5.59, respectively.

The results obtained from Examples 1-16 are illustrated in Table 1 below. Celite® 263LD is also included in the table below for purposes of comparison. Celite® 263LD is a commercially available sodium flux calcined diatomite product available for purchase from World Minerals, Inc.

TABLE 1

| | | Calcination | d₅₀ | d₉₀ | Cristobalite | | | |
|---|---|---|---|---|---|---|---|---|
| | Flux | Temp | (μm) | (μm) | (wt %) | L | a | b |
| Celite ® 263LD | Na₂CO₃ | N/A | 12.18 | 22.69 | 39.7 | 96.59 | 0.09 | 1.31 |
| (comparative) | | | | | | | | |
| Example 1 | 2 wt % | 800° C. | 21.00 | 89.55 | 1.7 | 92.39 | 0.43 | 4.99 |
| | Na₂CO₃ | | | | | | | |
| Example 2 | 4 wt % | 800° C. | 27.74 | 107.2 | 4.9 | 91.89 | 0.29 | 4.31 |
| | Na₂CO₃ | | | | | | | |
| Example 3 | 6 wt % | 800° C. | 33.53 | 120.4 | 7.4 | 90.94 | 0.26 | 3.59 |
| | Na₂CO₃ | | | | | | | |
| Example 4 | 8 wt % | 800° C. | 39.42 | 130.9 | 11.9 | 91.06 | 0.26 | 3.70 |
| | Na₂CO₃ | | | | | | | |
| Example 5 | 2 wt % | 800° C. | 16.83 | 75.68 | 0.1 | 91.49 | 0.64 | 5.44 |
| | K₂CO₃ | | | | | | | |
| Example 6 | 4 wt % | 800° C. | 17.96 | 89.92 | 0.3 | 91.29 | 0.41 | 4.83 |
| | K₂CO₃ | | | | | | | |
| Example 7 | 6 wt % | 800° C. | 19.32 | 122.6 | 0.5 | 92.32 | 0.48 | 5.04 |
| | K₂CO₃ | | | | | | | |
| Example 8 | 8 wt % | 800° C. | 19.98 | 119.70 | 0.5 | 91.57 | 0.35 | 4.70 |
| | K₂CO₃ | | | | | | | |
| Example 9 | 4 wt % | 900° C. | 45.36 | 128.10 | 23.2 | 94.18 | 0.28 | 4.21 |
| | Na₂CO₃ | | | | | | | |
| Example 10 | 4 wt % | 900° C. | 28.00 | 97.34 | 1.6 | 92.98 | 0.72 | 5.52 |
| | K₂CO₃ | | | | | | | |
| Example 11 | 4 wt % | 900° C. | 28.60 | 109.30 | 0.6 | 92.75 | 0.84 | 5.69 |
| | Rb₂CO₃ | | | | | | | |
| Example 12 | 4 wt % | 900° C. | 19.35 | 70.52 | <0.1 | 93.39 | 0.90 | 5.73 |
| | Cs₂CO₃ | | | | | | | |
| Example 13 | 4 wt % | 800° C. | 26.01 | 96.34 | 9.1 | 94.12 | 0.41 | 4.85 |
| | Na₂CO₃ | | | | | | | |
| Example 14 | 4 wt % | 800° C. | 21.84 | 93.80 | 15.5 | 94.50 | 0.39 | 4.49 |
| | Na₂CO₃ | | | | | | | |
| Example 15 | 4 wt % | 800° C. | 19.95 | 95.40 | 0.5 | 93.36 | 0.70 | 5.40 |
| | K₂CO₃ | | | | | | | |
| Example 16 | 4 wt % | 800° C. | 27.87 | 108.60 | 0.7 | 93.29 | 0.81 | 5.59 |
| | K₂CO₃ | | | | | | | |

As shown in Examples 1-16 above, flux calcination of diatomite feed materials in accordance with the present disclosure may provide flux calcined diatomite products having a reduced cristobalite content and improved whiteness. In addition, the cristobalite content of the diatomite products is significantly reduced with the use of at least one flux comprising at least one alkali metal chosen from potassium, rubidium, and cesium, without adversely impacting the whiteness of the product.

### Example 17

A sample of the diatomite product of Example 7 was compounded into Exxon Mobile low density polyethylene (LDPE) LD165B resin to make a plaque by injection molding at 15 wt % filler loading. The plaque had Hunter L, a, and b values of 59.12, 0.06, and 10.59, respectively.

### Example 18

To reduce the yellowness of the sample, 0.03 wt % of Nubiola (Norcross, Ga.) Nubiperf FG-75 was added to a sample of Example 7. After mixing, the ultramarine blue doped sample had Hunter L, a, and b values of 91.50, −0.21, and 3.57, respectively. An LDPE plaque made from this sample according to Example 17 had Hunter L, a, and b values of 56.45, −0.96, and 8.61, respectively.

The results obtained from Examples 17 and 18 are illustrated in Table 2 below. Measurements for a plaque made according to Example 17 using Celite® 263LD is also included in the table below for purposes of comparison.

TABLE 2

| | L | a | b |
|---|---|---|---|
| Example 17 | 59.12 | 0.06 | 10.59 |
| Example 18 | 56.45 | −0.96 | 8.61 |
| Celite ® 263LD | 56.84 | 0.10 | 7.56 |

As shown in Examples 17 and 18 above, LDPE films produced using diatomite products of the present disclosure exhibit whiteness properties comparable to those produced using the known commercial product, Celite® 263LD.

### Example 19

A sample of Example 7 was classified using an air classifier. The cyclone fraction product had a median particle size of 13.6 microns and Hunter L, a, and b values of 90.94, 0.61, and 5.55, respectively. A LDPE film containing 2000 ppm of this sample was prepared and its anti-blocking properties were measured. The film had an induced blocking of 26.84 g and a haze of 6.81%.

### Example 20

A sample of Example 7 was brush screened through a 230 mesh screen. The screened product had a median particle size of 15.3 microns and Hunter L, a, and b values of 92.14, 0.25, and 4.56, respectively. A LDPE film containing 2000 ppm of this sample was prepared and its anti-blocking properties were measured. The film had an induced blocking of 20.82 g and a haze of 6.59%.

The results obtained from Examples 19 and 20 are illustrated in Table 3 below. Measurements for a LDPE film containing 2000 ppm of Celite® 263LD is also included in the table below for purposes of comparison.

TABLE 3

| | Loading | Induced | Standard | | Standard |
|---|---|---|---|---|---|
| | (ppm) | Blocking (g) | Deviation | Haze (%) | Deviation |
| Example 19 | 2000 | 26.84 | 3.09 | 6.81 | 0.180 |
| Example 20 | 2000 | 20.82 | 2.53 | 6.59 | 0.263 |
| Celite ® | 2000 | 20.98 | 3.91 | 5.96 | 0.165 |
| 263LD | | | | | |

As shown in Examples 19 and 20 above, LDPE films produced using diatomite products of the present disclosure exhibit anti-blocking properties comparable to those produced using the known commercial product, Celite®263LD.

Various diatomite feed materials were evaluated by chemical analysis using X-ray fluorescence (XRF) methods, as discussed above. The results of the chemical analyses, indicated by weight %, are illustrated below in Table 4.

TABLE 4

| Feed | Al₂O₃ | SiO₂ | Fe₂O₃ |
|---|---|---|---|
| Alicante Kiln Feed | 0.75 | 90.97 | 0.23 |
| Lompoc Kiln Feed | 4.25 | 91.29 | 1.49 |
| Mexico Celite ® S | 4.55 | 92.16 | 2.05 |

As shown in Table 4 above, the diatomite feed from deposits in or near Alicante, Spain, as may be accordance with the present disclosure, exhibits lower iron content as compared to diatomite feeds from Mexico and Lompoc, Calif.

1-82. (canceled)

83. A filled polymer composition comprising a polymer and a calcined diatomite composition having a cristobalite content of less than about 5% by weight relative to the total weight of the composition and a whiteness of at least about 90.

84. The composition of claim 83, wherein the calcined diatomite has a cristobalite content of less than about 2% by weight.

85. The composition of claim 83, wherein the calcined diatomite has a cristobalite content of less than about 1% by weight.

86. The composition of claim 83, wherein the calcined diatomite has a cristobalite content of less than about 0.5% by weight.

87. The composition of claim 83, wherein the calcined diatomite has a whiteness of greater than about 91.

88. The composition of claim 83, wherein the calcined diatomite has a whiteness of greater than about 93.

89. The composition of claim 83, wherein the calcined diatomite has been flux calcined in the presence of at least one flux comprising at least one alkali metal chosen from potassium, rubidium, and cesium.

90. The composition of claim 83, wherein the calcined diatomite has a mean diameter of less than about 40 μm.

91. The composition of claim 83, wherein the calcined diatomite has a mean diameter of less than about 20 μm.

92. The composition of claim 83, wherein the calcined diatomite has a mean diameter of less than about 10 μm.

93. The composition of claim 83, wherein the calcined diatomite has a d₉₀ of less than about 50 μm.

94. The composition of claim 83, wherein the calcined diatomite has a d₉₀ of less than about 20 μm.

95. The composition of claim 83, wherein the calcined diatomite has an iron content of less than about 0.5% by weight relative to the total weight of the composition.

96. The composition of claim 83, wherein the calcined diatomite has a Hunter a value of less than about 1.

97. The composition of claim 83, wherein the calcined diatomite has a Hunter b value of less than about 8.

98. The composition of claim 83, wherein the calcined diatomite has a Hunter b value of less than about 4.

99. The composition of claim 83, wherein the polymer comprises polyethylene.

100. The composition of claim 99, wherein the polyethylene comprises a low density polyethylene (LDPE).

101. The composition of claim 83, wherein the filled polymer composition is a coating.

102. The composition of claim 83, wherein the filled polymer composition is a paint.
